(19) United States
(12) Patent Application Publication
(10) Pub. No.: US 2025/0239132 A1
(43) Pub. Date: Jul. 24, 2025

(54) DETECTING THEME GROUPINGS THAT ARE TYPICALLY PLAYED TOGETHER IN ELECTRONIC GAMES

(71) Applicant: IGT, Las Vegas, NV (US)

(72) Inventors: Brandt Balgooyen, Las Vegas, NV (US); Michael Russ, Graz (AT); Soheil Latifi, Brampton (CA); Stefan Keilwert, St. Josef (AT)

(21) Appl. No.: 18/416,400

(22) Filed: Jan. 18, 2024

(51) Int. Cl. G07F 17/32

(52) U.S. Cl. CPC G07F 17/3237; G07F 17/3234

(57) ABSTRACT

Embodiments of the present disclosure are directed to detecting relationship between themes of electronic games. According to one embodiment, detecting groups of electronic game themes can comprise collecting, from a plurality of electronic games, information related to a player of each electronic game and a theme of each electronic game. A first data table can be generated based on the collected information related to the player of each electronic game and the theme of each electronic game. A plurality of statistics indicating relationships between two or more themes can be calculated from the first data table and a second data table comprising the plurality of statistics indicating relationships between two or more themes of the plurality of electronic games can be generated. An indication of the relationships between two or more themes of the plurality of electronic games can be provided based on the second data table.

### BACKGROUND

The present disclosure is generally directed to managing electronic games in a gaming venue and more particularly to detecting groups of game themes that are played together by players.

Gaming systems such as Electronic Gaming Machines (EGMs) in a casino or other gaming venue commonly offer casino games via a computer hardware system which includes a video terminal within a cabinet and is linked to broader, software-based floor management and accounting systems. One aspect of such electronics games is the magnitude of data collected by the floor management and accounting systems. Currently, with respect to traditional floor management and accounting systems, there exist no methods for casino properties or other gaming venues to understand which game themes or game titles are typically played together by players.

### BRIEF SUMMARY

Embodiments of the present disclosure are directed to detecting relationship between themes of electronic games. According to one embodiment, a method for detecting groups of electronic game themes can comprise collecting, from a plurality of electronic games, information related to a player of each electronic game and a theme of each electronic game. A first data table can be generated based on the collected information related to the player of each electronic game and the theme of each electronic game. A plurality of statistics indicating relationships between two or more themes of the plurality of electronic games can be calculated from the first data table and a second data table comprising the plurality of statistics indicating relationships between two or more themes of the plurality of electronic games can be generated. An indication of the relationships between two or more themes of the plurality of electronic games can be provided based on the second data table. In some cases, the plurality of electronic games can comprise games on a single, multi-game gaming system. Additionally, or alternatively, the plurality of electronic games can comprise games on a plurality of gaming systems.

For example, providing the indication of the relationships between two or more themes of the plurality of electronic games can comprise providing a report. In another example, providing the indication of the relationships between two or more themes of the plurality of electronic games can additionally, or alternatively, comprise providing a dashboard in a graphical user interface. The indications of the relationships between two or more themes of the plurality of electronic games can comprise indications of game themes that are played together. Additionally, or alternatively, the indications of the relationships between two or more themes of the plurality of electronic games can comprise an indication of a common characteristic in the two or more themes.

According to another embodiment, a system can comprise a processor and a memory coupled with and readable by the processor. The memory can store therein a set of instructions which, when executed by the processor, causes the processor to collect, from a plurality of electronic games, information related to a player of each electronic game and a theme of each electronic game, generate a first data table based on the collected information related to the player of each electronic game and the theme of each electronic game, calculate, from the first data table, a plurality of statistics indicating relationships between two or more themes of the plurality of electronic games, generate a second data table comprising the plurality of statistics indicating relationships between two or more themes of the plurality of electronic games, and provide an indication of the relationships between two or more themes of the plurality of electronic games based on the second data table.

The indications of the relationships between two or more themes of the plurality of electronic games can comprise indications of game themes that are played together. Additionally, or alternatively, the indications of the relationships between two or more themes of the plurality of electronic games can comprise indications of game themes that are not played together. The indications of the relationships between two or more themes of the plurality of electronic games can additionally, or alternatively, comprise indications of game themes that are played together by problem gamblers.

Providing the indication of the relationship between the two or more themes of the plurality of electronic games can comprise reordering a list of available games in a multi-game gaming system. Additionally, or alternatively, providing the indication of the relationship between the two or more themes of the plurality of electronic games can comprise providing, in a first electronic game of the plurality of electronic games a suggestion of a second electronic game of the plurality of electronic games based on the relationship between the two or more themes of the plurality of electronic games. Providing the indication of the relationship between the two or more themes of the plurality of electronic games can additionally, or alternatively, comprise providing a suggested floor configuration for a gaming venue.

According to yet another embodiment, a non-transitory, computer-readable medium comprising a set of instructions stored therein which, when executed by a processor, causes the processor to collect, from a plurality of electronic games, information related to a player of each electronic game and a theme of each electronic game, generate a first data table based on the collected information related to the player of each electronic game and the theme of each electronic game, calculate, from the first data table, a plurality of statistics indicating relationships between two or more themes of the plurality of electronic games, generate a second data table comprising the plurality of statistics indicating relationships between two or more themes of the plurality of electronic games, and provide an indication of the relationships between two or more themes of the plurality of electronic games based on the second data table. The indications of the relationships between two or more themes of the plurality of electronic games can further comprise indications of player demographics.

Providing the indication of the relationships between two or more themes of the plurality of electronic games can comprise changing electronic games available in a multi-game gaming system based on current demographics of players in a gaming venue. Additionally, or alternatively, providing the indication of the relationships between two or more themes of the plurality of electronic games can comprise downloading an electronic game to a gaming system. Providing the indication of the relationships between two or more themes of the plurality of electronic games can additionally, or alternatively, comprise assigning a tag to each of the two or more themes of the plurality of electronic games. In such cases, the instructions further cause the processor to generate an association graph based on the assigned tags.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional detail of components of an exemplary game management system according to one embodiment of the present disclosure.

FIG. 3 is a block diagram illustrating additional details of components of an exemplary gaming system according to one embodiment of the present disclosure.

FIG. 4 is a flowchart illustrating an exemplary process for detecting groups of electronic game themes according to one embodiment of the present disclosure.

FIG. 5 is a flowchart illustrating an exemplary process for providing indications of detected electronic game theme groups according to another embodiment of the present disclosure.

### DETAILED DESCRIPTION

Embodiments of the present disclosure are directed to detecting groups of game themes for electronic games that are typically played together by players in a casino or other gaming venue. Embodiments described herein operators of the casino or other gaming venue to understand which groupings of themes are typically played together. Moreover, reports generated by various embodiments can include groupings of themes arranged by score. This allows the operator to understand the relative affinity of theme co-play. The operator may decide to choose how to arrange the theme layout of the casino or gaming venue floor. Additionally, or alternatively, the operator may decide how to load groupings of themes on multi-game gaming systems.

There are several reasons why operators may be interested in understanding which game themes or titles are typically played together. For example, the operator may want to consider per-theme banking of gaming systems on the gaming venue floor. That is, if an operator is interested in optimizing the floor layout by theme arrangement, it is in the operator's interest to understand which game themes are typically played together. Additionally, or alternatively, the operator may want to consider per-multi-themed gaming systems. That is, the operator may desire to understand which themes are typically played together so that multi-themed gaming systems can be loaded with themes that are popular to play together during a trip to a property. Ultimately, optimizing theme arrangements can be highly correlated to optimizing gaming venue revenue. That is, if themes typically played together can be physically located closer to one another or are loaded on the same multi-game gaming system, the more likely a player may increase their spend.

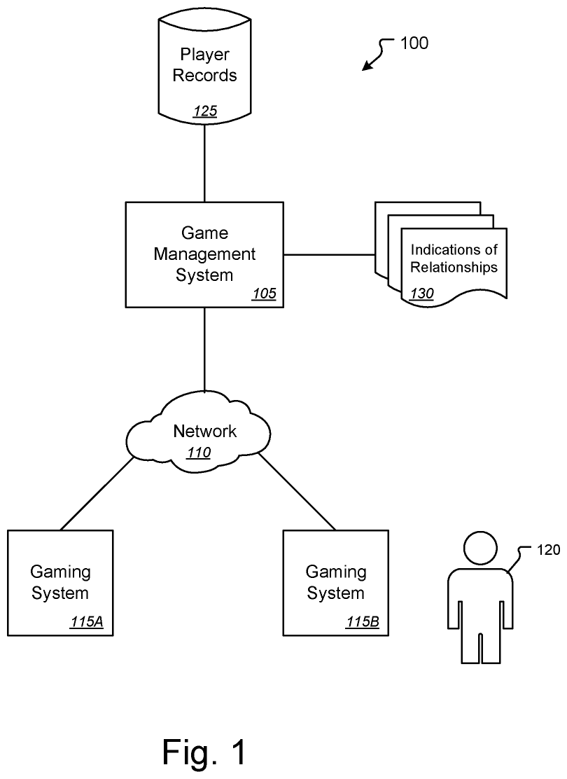

FIG. 1 is a block diagram illustrating an exemplary environment in which embodiments of the present disclosure can be implemented. As illustrated in this example, the environment 100 can include a game management system 105. The game management system 105 can comprise any one or more servers and/or computing devices as known in the art. The game management system 105 can be coupled with a communications network 110. The communications network 110 can comprise any one or more wired and/or wireless, local-area and/or wide-area networks as known in the art including, but not limited to, the Internet. Any number of gaming systems 115A and 115B can also be coupled with the communications network 110. The gaming systems 115A and 115B can Electronic Gaming Machines (EGMs) or other systems executing any number of electronic game including, but not limited to, slots, video slots, video poker, keno, blackjack, etc. to be played by a player 120, e.g., in a casino or other gaming venue.

Generally speaking, the as the player 120 plays an electronic game on a gaming system 115B. the game management system can collect data about the player 120 and the game 115. According to one embodiment, the game management system 105 can aggregate the collected data and apply statistical methodologies to determine which groupings of game themes are typically played together. When this detection process has acquired enough data, the game management system 105 can generate reports and/or other indications 130 that not only show grouping of themes played together, but also numerically and/or visually show the relative magnitude of affinity of pairwise theme play.

More specifically, the collected data can include, but is not limited to, a player ID, player trip ID, and theme names played. The game management system 105 can then apply calculations to this data to generate a set of statistics including, but not limited to, a start theme, end theme, lift score, support score, confidence score, and/or others. A lift score is generally defined as a measure of the effectiveness of a predictive model calculated as the ratio between the results obtained with and without the predictive model. A support score is generally defined as a measure of a degree of relationship. A confidence score is defined as a measure of probability of a correct identification of a result. These statistics can then be used by the game management system 105 to generate indications 130 of the relationship between game themes. These indications 130 can be present in reporting and/or interactive dashboards that allow the casino or gaming venue operator to understand which groupings of game themes are typically played together.

These indications 130 can be used to detect slot theme groupings on the same gaming system in the case of a multi-game gaming system. This analysis can include tracking the number of spins or amount of time played per game, the number and titles of games played, and the order of games played on the same gaming system. In this case, the game session and the games played within the session can be recreated. Player ID tracking by the game management system 105 and based on a set of player records 125 can be used in this approach. In other cases a session end can be determined with a cash out or credit meter running zero, and each game change within the session can be tracked anonymously.

Additionally, or alternatively, the generated indications of relationships 130 can be used to detect game theme groupings across multiple systems in a gaming venue. More specifically, player ID tracking, based on the set of player records 125 can be performed by the game management system 105 to trace back from which gaming system and/or game to which gaming system and/or game the player moved. Whether games are typically played together can be determined relative to whether the game is on a multi-game gaming system or single game gaming system, single-standing gaming system or bank configuration gaming system, distance between games and/or gaming systems, visual game characteristics, e.g., similar theme topic, similar colors, similar style, etc., game mechanics, e.g., similar wager levels, similar win lines, same or similar denom, etc., cabinet characteristics, e.g., same or similar cabinet, a new cabinet generation, same manufacturer, etc., win volatility, e.g., similar jackpot height, similar jackpot type such as a progressive, etc. From these characteristics, the game management system 105 can determine cross-games similarities detection system. That is, the game management system 1056 can derive not only which themes are usually played together but additionally, a reason why these themes are played together.

According to one embodiment, the game management system 105 can use the indications of relationships 130 between game to re-organize games shown in a game chooser in a multi-game gaming system. That is, once the operator applies the latest version of a report for their casino games, it can be embedded in a gaming system's game chooser which games correlate (based on the latest report). Thus, when a player chooses to play a game A, in the background the chooser would re-configure the order of listed games so that games that are typically played together with game A appear as the very next entries in the game chooser. In some cases, instead of waiting for a manually applied update based on the latest report, this process could be ongoing and thus, provide a dynamic chooser, based on time series indices. So, it is more dynamic, more in “real-time”, and does not require a manual update as the system is detecting these groupings continuously. For example, “In the last 5 days game C was played mostly together with game A.” This could even be different on a machine-by-machine basis or a area basis, i.e., instead of a venue-wide application. Additionally, or alternatively, the game management system 105 can detect the games that are least likely played together. In this case, those games can be listed at the very end of the game chooser list or can be removed from the list.

According to one embodiment, the game management system 105 can implement game-based cross binding for games that are typically played together or for which the operator wants to emphasize that they are played more together. That is, by having a player play a first game, and having the game management system 105 know which is the second game, often played with the first game, even during the play session of the first game, cross-game binding indication can be presented to the player, e.g. “Complete XY in this game, and if you then continue playing game Z to complete AB there, you get a reward C.”

According to one embodiment, the game management system 105 can determine game groupings based on customer interactions and demographics. In such cases, the gaming venue operator can identify from the indications of relationships 130 what demographic group and playstyles are not cared for in the casino, replacing the neglected games with the necessary ones. In some cases, the demographics may include a problem gambler demographic. Based on this games usually played together by problem gamblers can be identified and the games can be arranged so problem gambling is addressed, e.g., moved further apart, not presented together in a multi-game gaming system, etc.

According to one embodiment, the game management system 105 can provide a game grouping trajectory feature. This feature can show how a game changes groups through time, from a money-making game to beginner friendly to a “has been”, helping the operator to retire it at an appropriate time.

According to one embodiment, the game management system 105 can assign game tag based on groupings. That is the games can be assigned multiple tags based on their features, for example Egyptian, money maker, double screen, etc. can be assigned to the games. Based on multiple tags, the game management system 105 can generate associations graphs, providing insight on the games.

According to one embodiment, the game management system 105 can optimize game offerings depending on player demographics and time. For example, through trial and error or other methods, the game management system 105 can optimize a number of games offered in a multi-game product to tailor the offering to a targeted group of players. In some cases, the game management system can be connected to a casino management system (not shown here) and can receive information about present player demographics in the casino at a particular point in time in present/future and tailor the multi-game offerings accordingly.

According to one embodiment, the game management system 105 can tailor game composition of a multi-game system to individual players. Through the gaming system, the game management system can offer a functionality for players to press a button which triggers the game management system 105 to re-compose or shuffle the selected games in a multi-game chooser list for the gaming system according to player preferences, e.g., historical information maintained in player records 125. or to come up with a selection of games that players with similar preferences liked to play which can be determined based on player return rate, game performance, etc.

According to one embodiment, the game management system 105 can perform dynamic floor configuration. For example, the game management system 105 can dynamically download games to gaming systems based upon findings about which games players like to play together. In some cases, the game management system 105 can schedule automatic downloads, e.g., once a day, hourly, weekly etc. For example, a central gaming venue system (not shown here) can store game content and allowed game configurations for the specific operation and can connect to the game management system 105 which proposes/orchestrates content updates on the gaming systems. Game configuration can include, but is not limited to, math paytable version (payout percentage), available denominations, jackpot, double-up, and/or other available features.

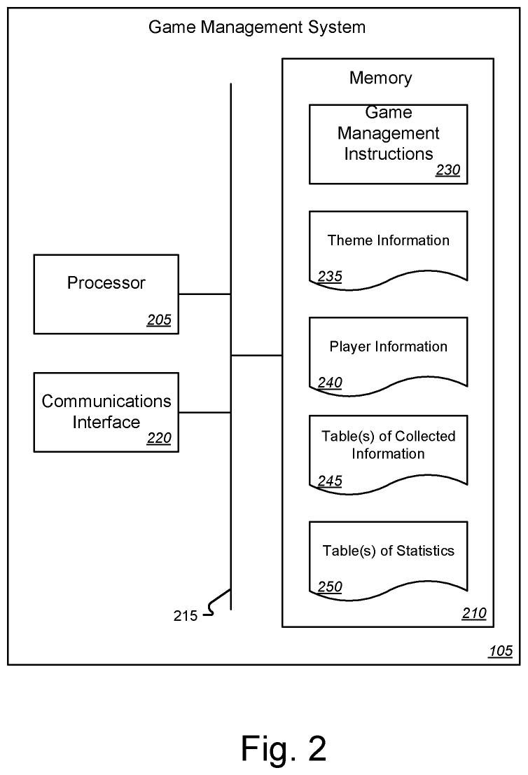

FIG. 2 is a block diagram illustrating additional detail of components of an exemplary game management system according to one embodiment of the present disclosure. As illustrated in this example, a game management system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the game management system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, a Bluetooth, WiFi, cellular, and/or other type of wireless communications interface. Via the communication interface(s) 220, the game management system 105 can communication with gaming systems 115 and/or other devices and/or systems through a communications network 110 as described above.

The memory 210 can store therein a set of game management instructions 230 which, when executed by the processor 205, cause the processor 205 to collect, from a plurality of electronic games 115A and 115B, information 240 related to a player 120 of each electronic game and theme information 235 of each electronic game. In some cases, the plurality of electronic games can comprise games on a single, multi-game gaming system. Additionally, or alternatively, the plurality of electronic games can comprise games on a plurality of gaming systems.

The game management instructions 230 can further cause the processor 205 to generate a first data table 245 based on the collected information 240 related to the player of each electronic game and the theme information 235 of each electronic game, calculate a plurality of statistics indicating relationships between two or more themes of the plurality of electronic games from the first data table 245, and generate a second data table 250 comprising the plurality of statistics indicating relationships between two or more themes of the plurality of electronic games, and provide one or more indications of the relationships between two or more themes of the plurality of electronic games based on the second data table 250.

The indications of the relationships between two or more themes of the plurality of electronic games can comprise indications of game themes that are played together. Additionally, or alternatively, the indications of the relationships between two or more themes of the plurality of electronic games can comprise an indication of a common characteristic in the two or more themes. The indications of the relationships between two or more themes of the plurality of electronic games can additionally, or alternatively, comprise indications of game themes that are played together. Additionally, or alternatively, the indications of the relationships between two or more themes of the plurality of electronic games can comprise indications of game themes that are not played together. The indications of the relationships between two or more themes of the plurality of electronic games can additionally, or alternatively, comprise indications of game themes that are played together by problem gamblers. Additionally, or alternatively, the indications of the relationships between two or more themes of the plurality of electronic games can further comprise indications of player demographics.

According to one embodiment, providing the indication of the relationships between two or more themes of the plurality of electronic games can comprise providing a report. Providing the indication of the relationships between two or more themes of the plurality of electronic games can additionally, or alternatively, comprise providing a dashboard in a graphical user interface. Additionally, or alternatively, providing the indication of the relationship between the two or more themes of the plurality of electronic games can comprise reordering a list of available games in a multi-game gaming system. Additionally, or alternatively, providing the indication of the relationship between the two or more themes of the plurality of electronic games can comprise providing, in a first electronic game of the plurality of electronic games a suggestion of a second electronic game of the plurality of electronic games based on the relationship between the two or more themes of the plurality of electronic games. Providing the indication of the relationship between the two or more themes of the plurality of electronic games can additionally, or alternatively, comprise providing a suggested floor configuration for a gaming venue. Additionally, or alternatively, providing the indication of the relationships between two or more themes of the plurality of electronic games can comprise changing electronic games available in a multi-game gaming system based on current demographics of players in a gaming venue. Additionally, or alternatively, providing the indication of the relationships between two or more themes of the plurality of electronic games can comprise downloading 55 one or more electronic games to one or more gaming systems. Providing the indication of the relationships between two or more themes of the plurality of electronic games can additionally, or alternatively, comprise assigning a tag to each of the two or more themes of the plurality of electronic games. In such cases, the game management instructions 230 can further cause the processor to generate an association graph based on the assigned tags and present the association graph, e.g., in a graphical user interface.

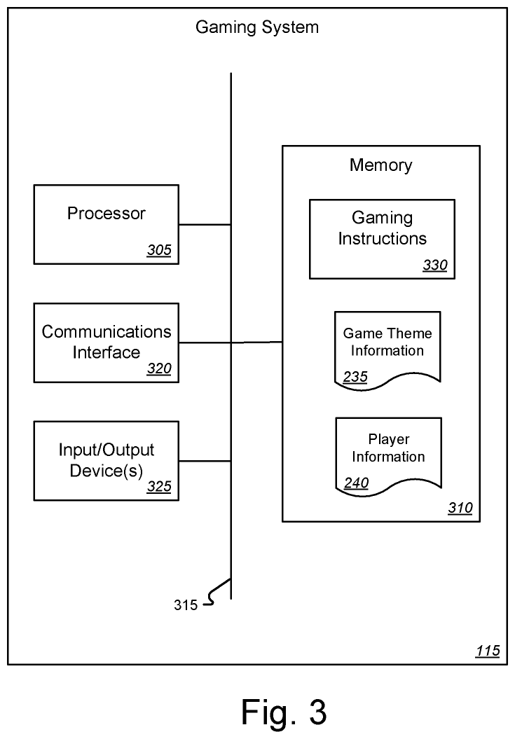

FIG. 3 is a block diagram illustrating additional details of components of an exemplary gaming system according to one embodiment of the present disclosure. As illustrated in this example, a gaming system 115, such as the second gaming system 115B described above, can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 and one or more input/output devices 325 via the communications bus 315. The communication interfaces 320 can comprise, for example, a Bluetooth, WiFi, cellular, and/or other type of wireless communications interface. The input/output devices 325 can include, but are not limited to a display device such as a Liquid Crystal Display (LCD), Light Emitting Diode (LED), Organic Light Emitting Diode (OLED), or other type of display, a ticket printer, etc.

The memory 310 can store therein a set of gaming instructions 330 which, when executed by the processor 305, cause the processor 305 to execute an electronic game. The electronic game can be any of a wide variety of electronic games of chance including, but not limited to, slots, video slots, video poker, keno, blackjack, etc. to be played by a player, e.g., in a casino or other gaming venue. During execution of the electronic game, the gaming instructions 330 can cause the processor 305 to collect game information 340, e.g., game status, player actions, etc., as well as player information 345, e.g., a player ID and/or other identifying information, provide this information to the game management system 105 through the communication interface(s) 320.

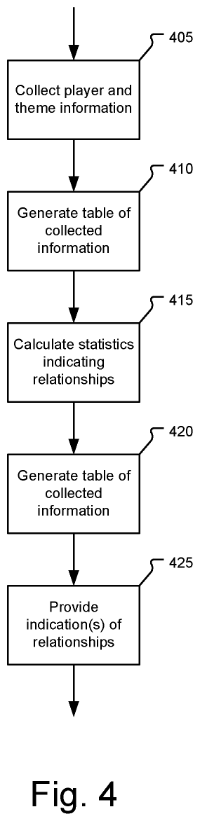

FIG. 4 is a flowchart illustrating an exemplary process for detecting groups of electronic game themes according to one embodiment of the present disclosure. As illustrated in this example, detecting groups of electronic game themes can comprise collecting 405, from a plurality of electronic games 115A and 115B, information related to a player 120 of each electronic game and a theme of each electronic game. In some cases, the plurality of electronic games can comprise games on a single, multi-game gaming system. Additionally, or alternatively, the plurality of electronic games can comprise games on a plurality of gaming systems. A first data table can be generated 410 based on the collected information related to the player of each electronic game and the theme of each electronic game. A plurality of statistics indicating relationships between two or more themes of the plurality of electronic games can be calculated 415 from the first data table and a second data table comprising the plurality of statistics indicating relationships between two or more themes of the plurality of electronic games can be generated 420. One or more indications of the relationships between two or more themes of the plurality of electronic games can be provided 425 based on the second data table.

The indications of the relationships between two or more themes of the plurality of electronic games can comprise indications of game themes that are played together. Additionally, or alternatively, the indications of the relationships between two or more themes of the plurality of electronic games can comprise an indication of a common characteristic in the two or more themes. The indications of the relationships between two or more themes of the plurality of electronic games can additionally, or alternatively, comprise indications of game themes that are played together. Additionally, or alternatively, the indications of the relationships between two or more themes of the plurality of electronic games can comprise indications of game themes that are not played together. The indications of the relationships between two or more themes of the plurality of electronic games can additionally, or alternatively, comprise indications of game themes that are played together by problem gamblers. Additionally, or alternatively, the indications of the relationships between two or more themes of the plurality of electronic games can further comprise indications of player demographics.

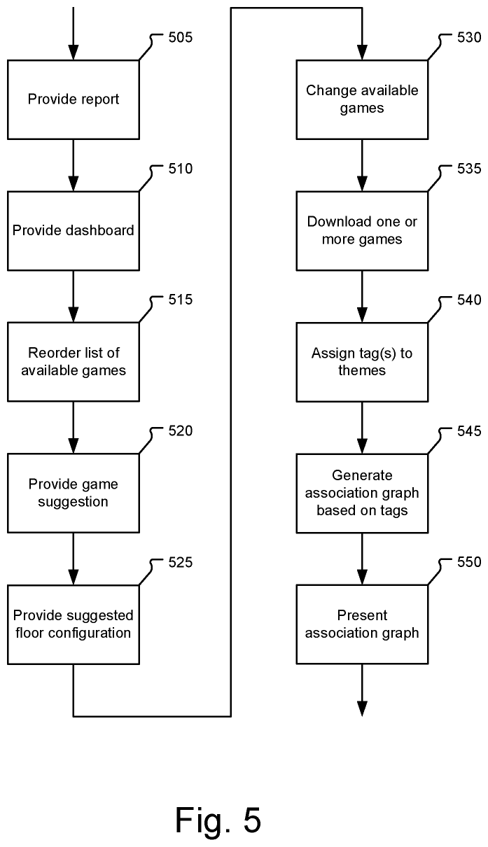

FIG. 5 is a flowchart illustrating an exemplary process for providing indications of detected electronic game theme groups according to another embodiment of the present disclosure. More specifically, this example illustrates various ways in which the identified relationships between themes can be presented, e.g., to a gaming venue manager or operator. It should be understood that any one, some, or all of these processes can be performed individually or together, and in various orders.

According to one embodiment, providing the indication of the relationships between two or more themes of the plurality of electronic games can comprise providing 505 a report. Providing the indication of the relationships between two or more themes of the plurality of electronic games can additionally, or alternatively, comprise providing 510 a dashboard in a graphical user interface. Additionally, or alternatively, providing the indication of the relationship between the two or more themes of the plurality of electronic games can comprise reordering 515 a list of available games in a multi-game gaming system. Additionally, or alternatively, providing the indication of the relationship between the two or more themes of the plurality of electronic games can comprise providing 520, in a first electronic game of the plurality of electronic games a suggestion of a second electronic game of the plurality of electronic games based on the relationship between the two or more themes of the plurality of electronic games. Providing the indication of the relationship between the two or more themes of the plurality of electronic games can additionally, or alternatively, comprise providing 525 a suggested floor configuration for a gaming venue. Additionally, or alternatively, providing the indication of the relationships between two or more themes of the plurality of electronic games can comprise changing 530 electronic games available in a multi-game gaming system based on current demographics of players in a gaming venue. Additionally, or alternatively, providing the indication of the relationships between two or more themes of the plurality of electronic games can comprise downloading 535 one or more electronic games to one or more gaming systems. Providing the indication of the relationships between two or more themes of the plurality of electronic games can additionally, or alternatively, comprise assigning 540 a tag to each of the two or more themes of the plurality of electronic games. In such cases, an association graph can be generated 545 based on the assigned tags and the association graph can be presented 550, e.g., in a graphical user interface.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for detecting groups of electronic game themes, the method comprising:
collecting, by a game management system, from a plurality of electronic games, information related to a player of each electronic game and a theme of each electronic game;
generating, by the game management system, a first data table based on the collected information related to the player of each electronic game and the theme of each electronic game;
calculating, by the game management system, from the first data table a plurality of statistics indicating relationships between two or more themes of the plurality of electronic games;
generating, by the game management system, a second data table comprising the plurality of statistics indicating relationships between two or more themes of the plurality of electronic games; and
providing, by the game management system, an indication of the relationships between two or more themes of the plurality of electronic games based on the second data table.

2. The method of claim 1, wherein providing the indication of the relationships between two or more themes of the plurality of electronic games comprises providing a report.

3. The method of claim 1, wherein providing the indication of the relationships between two or more themes of the plurality of electronic games comprises providing a dashboard in a graphical user interface.

4. The method of claim 1, wherein the plurality of electronic games comprises games on a single, multi-game gaming system.

5. The method of claim 1, wherein the plurality of electronic games comprises games on a plurality of gaming systems.

6. The method of claim 1, wherein the indications of the relationships between two or more themes of the plurality of electronic games comprise indications of game themes that are played together.

7. The method of claim 1, wherein the indications of the relationships between two or more themes of the plurality of electronic games comprises an indication of a common characteristic in the two or more themes.

8. A system comprising:
a processor; and
a memory coupled with and readable by the processor and storing therein a set of instructions which, when executed by the processor, causes the processor to:
collect, from a plurality of electronic games, information related to a player of each electronic game and a theme of each electronic game;
generate a first data table based on the collected information related to the player of each electronic game and the theme of each electronic game;
calculate, from the first data table, a plurality of statistics indicating relationships between two or more themes of the plurality of electronic games;
generate a second data table comprising the plurality of statistics indicating relationships between two or more themes of the plurality of electronic games; and
provide an indication of the relationships between two or more themes of the plurality of electronic games based on the second data table.

9. The system of claim 8, wherein providing the indication of the relationship between the two or more themes of the plurality of electronic games comprises reordering a list of available games in a multi-game gaming system.

10. The system of claim 8, wherein providing the indication of the relationship between the two or more themes of the plurality of electronic games comprises providing, in a first electronic game of the plurality of electronic games a suggestion of a second electronic game of the plurality of electronic games based on the relationship between the two or more themes of the plurality of electronic games.

11. The system of claim 8, wherein providing the indication of the relationship between the two or more themes of the plurality of electronic games comprises providing a suggested floor configuration for a gaming venue.

12. The system of claim 8, wherein the indications of the relationships between two or more themes of the plurality of electronic games comprise indications of game themes that are played together.

13. The system of claim 8, wherein the indications of the relationships between two or more themes of the plurality of electronic games further comprise indications of game themes that are not played together.

14. The system of claim 8, wherein the indications of the relationships between two or more themes of the plurality of electronic games further comprise indications of game themes that are played together by problem gamblers.

15. A non-transitory, computer-readable medium comprising a set of instructions stored therein which, when executed by a processor, causes the processor to:
collect, from a plurality of electronic games, information related to a player of each electronic game and a theme of each electronic game;
generate a first data table based on the collected information related to the player of each electronic game and the theme of each electronic game;
calculate, from the first data table, a plurality of statistics indicating relationships between two or more themes of the plurality of electronic games;
generate a second data table comprising the plurality of statistics indicating relationships between two or more themes of the plurality of electronic games; and
provide an indication of the relationships between two or more themes of the plurality of electronic games based on the second data table.

16. The non-transitory, computer-readable medium of claim 15, wherein the indications of the relationships between two or more themes of the plurality of electronic games further comprise indications of player demographics.

17. The non-transitory, computer-readable medium of claim 16, wherein providing the indication of the relationships between two or more themes of the plurality of electronic games comprises changing electronic games available in a multi-game gaming system based on current demographics of players in a gaming venue.

18. The non-transitory, computer-readable medium of claim 15, wherein providing the indication of the relationships between two or more themes of the plurality of electronic games further comprises downloading an electronic game to a gaming system.

19. The non-transitory, computer-readable medium of claim 15, wherein providing the indication of the relationships between two or more themes of the plurality of electronic games comprises assigning a tag to each of the two or more themes of the plurality of electronic games.

20. The non-transitory, computer-readable medium of claim 19, wherein the instructions further cause the processor to generate an association graph based on the assigned tags.
